(19) United States
(12) Patent Application Publication
(10) Pub. No.: US 2011/0209117 A1
(43) Pub. Date: Aug. 25, 2011

(54) METHODS AND SYSTEMS RELATED TO CREATION OF INTERACTIVE MULTIMDEDIA APPLICATIONS

(75) Inventors: Michael AGUSTIN, Round Rock, TX (US); Daniel L. TREIMAN, Round Rock, TX (US)

(73) Assignee: GAMESALAD, INC., Austin, TX (US)

(21) Appl. No.: 13/033,408

(22) Filed: Feb. 23, 2011

Related U.S. Application Data
(60) Provisional application No. 61/307,444, filed on Feb. 23, 2010.

(51) Int. Cl. G06F 9/44

(52) U.S. Cl. 717/109

(57) ABSTRACT

Creation of interactive games. At least some embodiments involve creating an interactive application by way of a graphical user interface in a declarative format. The interactive application created is represented in a portable format, also at least partially in a declaration format. Execution of an interactive game involves reading the portable format by a runtime engine, and creating by the runtime engine executable routines consistent with the interactive application.

### CROSS-REFERENCE TO RELATED APPLICATIONS

This application claims the benefit of provisional patent application Ser. No. 61/307,444 filed Feb. 23, 2010, titled “System, Method and File Structure for Programming Interactive Multimedia Applications”, which provisional application is incorporated by reference herein as if reproduced in full below.

### BACKGROUND

Interactive multimedia applications, such as computer games, have become a major market component in the world economy. The electronic game markets comprise not only massive online multi-player games and console games, but also games for portable multi-function computing devices such as iPhone® and iPad® brand devices available from Apple, Inc. of Cupertino, Calif.

Interactive multimedia application creation is a highly creative art, and as such is attractive to those with creative personality types. On the other hand, computer programming has generally been the domain of logical, methodical personalities, who view the world as a discrete series of steps. While in some cases the highly creative personality will coincide with the highly logical personality, in most cases the abilities do not reside fully in a single individual. For that reason, many highly creative people find it difficult to write source code for programming of interactive multimedia applications.

Another issue that faces developers is varying platforms upon which multimedia applications may be executed. A significant amount of work on the part of the programmer may be required to create an executable version of an interactive multimedia application for different platforms (e.g., on processors that implement different instruction sets) even when appearance and interaction as between the platforms seems exactly the same.

Thus, any advance which makes the programming easier, and/or which makes creating executable versions of an application available for many different platforms easier, would provide a competitive advantage in the marketplace.

### BRIEF DESCRIPTION OF THE DRAWINGS

For a detailed description of exemplary embodiments, reference will now be made to the accompanying drawings in which:

FIG. 1 shows a block diagram of components used in interactive game creation in accordance with at least some embodiments;

FIG. 2 shows a block diagram of creation of executable deliverables of interactive games in accordance with at least some embodiments;

FIG. 3 shows a tree structure that logically depicts game organization in accordance with at least some embodiments;

FIG. 4 shows a tree structure that logically depicts various aspects of actors in accordance with at least some embodiments;

FIG. 5 shows a tree structure that logically depicts a representation of a game in a portable game format in accordance with at least some embodiments;

FIG. 6 shows an illustrative project editor view, in accordance with at least some embodiments;

FIG. 7 shows a portion of the project editor view when the manager tab is visible, in accordance with at least some embodiments;

FIG. 8 shows an illustrative scene editor view, in accordance with at least some embodiments;

FIG. 9 shows a portion of the scene editor view when the inspector area shows the game attributes view, in accordance with at least some embodiments;

FIG. 10 shows a portion of the scene editor view when the inspector area shows the game devices view, in accordance with at least some embodiments;

FIG. 11 shows a portion of the scene editor view when the inspector area shows the scene attributes view, in accordance with at least some embodiments;

FIG. 12 shows a portion of the scene editor view when the inspector area shows the scene layers view, in accordance with at least some embodiments;

FIG. 13 shows a portion of the scene editor view when then scene area shows a layout view, in accordance with at least some embodiments;

FIG. 14 shows a portion of the scene editor view when the scene area shows a camera mode, in accordance with at least some embodiments;

FIG. 15 shows a portion of the scene editor view when the media browser shows an image view, in accordance with at least some embodiments;

FIG. 16 shows a portion of the scene editor view when the media browser shows an audio view, in accordance with at least some embodiments;

FIG. 17 shows an illustrative actor editor view, in accordance with at least some embodiments;

FIG. 18 shows a more detailed view of the behavior pane of the actor editor view, in accordance with at least some embodiments;

FIG. 19 shows an expression editor in accordance with at least some embodiments;

FIG. 20 shows a block diagram representation of a runtime engine in accordance with at least some embodiments;

FIG. 21 shows a method in accordance with at least some embodiments; and

FIG. 22 shows a computer system in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to an interactive multimedia application development platform. More particularly, at least some embodiments are directed a platform that enables “visual” (e.g., drag and drop) programming in a declarative programming style. At least some embodiments are directed to representing an interactive multimedia application in a format which is portable across many execution platforms. The various embodiments were developed in the context of the interactive multimedia applications being interactive multimedia computer games, and thus the specification is based on the developmental context; however, the developmental context shall not be read as limitation as to the scope of the various embodiments. The specification first turns to a high level description of the various software components associated with application creation.

Overview

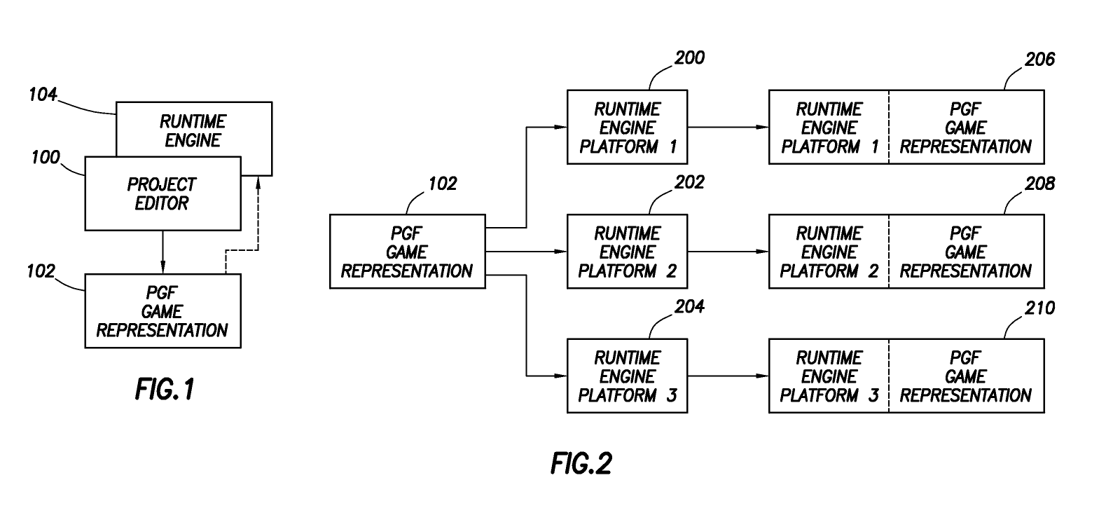

FIG. 1 shows, in block diagram form, a high level overview of the various components used in game creation in accordance with at least some embodiments. In particular, interactive games may be created and/or edited by way of a project editor 100. In a particular embodiment, the project editor 100 is a browser-based executable program, and in yet still other cases the project editor may be a standalone software package that executes on the computer system. In accordance with at least some embodiments, the project editor 100 enables creation and/or editing of a game visually, without the need to create source code. Various screens and functions of the project editor are discussed more below.

The process of creating a game by interaction with the project editor 100 creates a representation of the game 102 in a format termed herein portable game format (PGF). The various attributes of PGF game representations will be discussed more below, but suffice it to say for this portion of the specification that PGF game representations are not source code, and are not compiled in the traditional sense; rather, the PGF game representations define the game flow or design in such a way that a runtime engine may interpret the information contained in the PGF game representation, and based on the interpretation the runtime engine becomes the executable code of the game.

Still referring to FIG. 1, the project editor 100 is associated with a runtime engine 104. The runtime engine 104 reads the game 102 in the PGF game representation and configures itself to execute or play out the game, including creation of the visual aspects and reading data from input devices such as the keyboard, mouse, touch screen, accelerometers, and inclinometers. The project editor 100 is associated with the runtime engine 104 such that, at various times during the creation process, the user may run the game, or portions of the game, to evaluation game development and make decisions and/or changes in game play.

FIG. 1 illustrates the creation environment; however, in order to make the game available on different computer systems (i.e., different platforms), the PGF game representation is combined with a runtime engine configured for the specific computer system. FIG. 2 shows in block diagram form combining a PGF game representation with a runtime engine. In particular, FIG. 2 illustrates a game 102 in PGF game format, along with an illustrative three runtime engines 200, 202, and 204. Each runtime engine is specifically configured for a particular type of computer system. For example, runtime engine 200 may be configured for execution on an iPhone® brand product, runtime engine 202 may be configured for execution on an iPad® brand product, and runtime engine 204 may be configured for execution on a laptop or desktop computer systems (e.g., a computer system running a Windows® brand operating system available from Microsoft Corporation of Redmond, Wash.).

While a runtime engine may be or may become the executable code for a game, the runtime engine itself does not know or contain the game play; rather, to create a self contained product (i.e., a deliverable) for execution on a computer system, a particular runtime engine is packaged with the game 102 in the PGF game representation. In the example of FIG. 2, the game 102 in the PGF game representation is combined with the runtime engine 200 to create a deliverable 206 that will be executable on a first illustrative type of computer system. Likewise, the game 102 in the PGF game representation is combined with the runtime engine 202 to create a deliverable 208 that will be executable on a second illustrative type of computer system. Finally, the game 102 in the PGF game representation is combined with the runtime engine 204 to create a deliverable 210 that will be executable on a third illustrative type of computer system. As illustrated by FIG. 2, however, the combing to create the respective deliverables in accordance with a particular embodiment is a grouping of the game 102 and the respective engine 200, 202, and 204. In some cases, the combining is merely a logical grouping of the files that represent the game 102 and the file(s) that are the runtime engine such that the respective runtime engine knows the location and can read the files of the game 102. In a particular case, the combining is merely a concatenation of the various files into a single deliverable, but where the runtime engine and game are discernible portions. In some cases, for example on large games, the game 102 may be compressed, such that one of the first actions the runtime engine may take during execution is uncompressing the files that represent the game to a known location for reading and interpretation.

Before proceeding, a particular point is highlighted. That is, in a particular embodiment each deliverable 206, 208, or 210 contains both executable code for the runtime engine and a representation of the game 102 in the PGF game format (e.g., direct representation, compressed version, encrypted version). The game 102 is not “compiled” in the traditional sense before being provided to the computer system on which the game 102 will run. Moreover, unlike platform independent programming languages, such as the JAVA® brand programming language (available from Oracle America, Inc. of Redwood Shores, Calif.) in which a program written in the JAVA® brand language is the deliverable and the computer system must already contain a program which executes the JAVA® brand language, a deliverable contains the runtime engine which interprets the game 102 in the PGF game representation. The specification now turns to game creation.

FIG. 3 illustrates a tree structure that logically depicts various aspects of game organization in accordance with at least some embodiments. In particular, FIG. 3 shows that a game 300 contains scenes. In the illustrative case of FIG. 3, game 300 contains three scenes 302, 304, and 306, but any number of scenes may be equivalently used, including “simple” games containing only one scene. Scenes may take place in any order. Within each scene are actors. For example, scene 302 illustrative contains three actors 308, 310, and 312. In a particular embodiment, every object in scene is an actor. For example, consider a classic arcade-style game where the player controls direction and acceleration of a space ship, and also controls firing of laser pulses that strike and destroy asteroids. Not only is the space ship an actor, but each asteroid is an actor, and each laser pulse is an actor.

Actors are not limited to particular scenes, and in fact an actor may span multiple scenes. In the example of FIG. 3, actor 308 spans both scene 302 and scene 304. Likewise, an actor may reside within a single scene, such as illustrative actor 314 residing only in scene 304, and actor 316 residing only in scene 306.

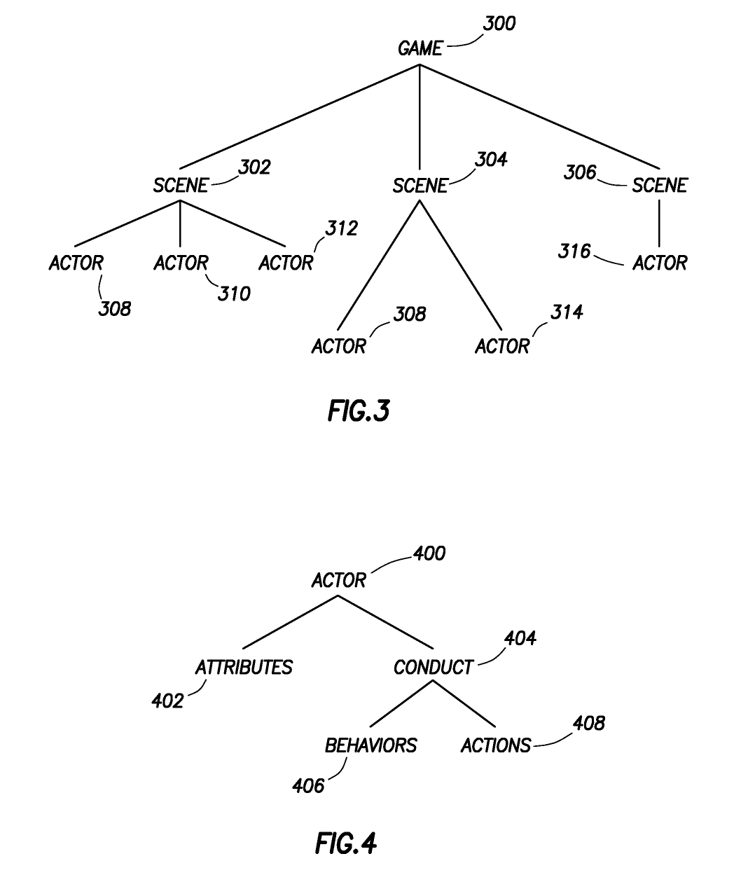

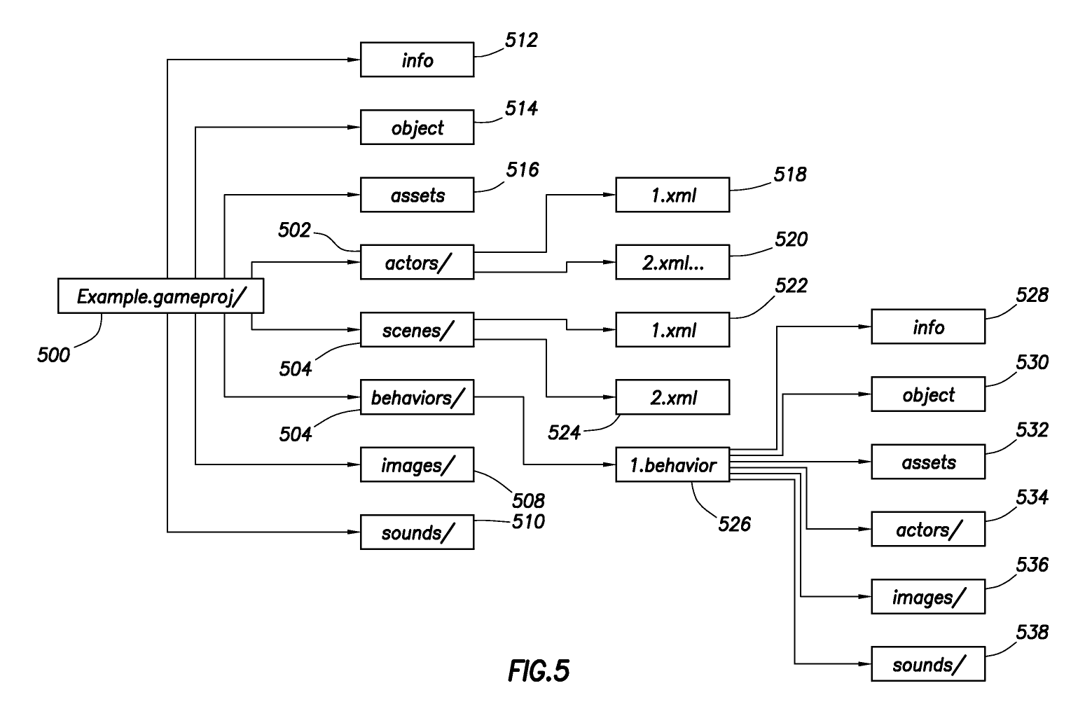

FIG. 4 illustrates a tree structure that logically depicts various aspects of an actor in accordance with at least some embodiments. In particular, FIG. 4 shows that an actor 400 is comprised of attributes 402 and conduct 404. Attributes 402 may define characteristics of the actor 400, such as initial position in the scene, size of the actor, color, rotational angle, the name of an image rendered on a screen that represents the actor, and visibility (some actors may be invisible). Moreover, attributes 402 may define data about how the actor 400 acts or reacts in a physics sense, such as whether the actor 400 is moveable, and if moveable the density of the actor 400 (e.g., density may control rate of acceleration), and friction of the actor 400 (e.g., may control how quickly the actor 400 decelerates in the absence of an applied force).

Conduct 404 of illustrative actor 400 may be considered to comprise both behaviors 406 and actions 408. In accordance with particular embodiments, when a behavior 406 is activated, the result is “persistent” or “continuous”. Consider, for example, the illustrative Accelerate behavior. The Accelerate behavior causes an actor to accelerate in a particular direction. In the example of the arcade-style asteroid game, the Accelerate behavior may be assigned to the space ship actor, and when the Accelerate behavior is activated (such as by pressing a key on an interface device), the space ship actor may then accelerate in a particular direction. As yet another example of a behavior, a Move To behavior causes an actor to move to a specified coordinate relative to the actor or scene.

By contrast, when an action 408 is activated, an “instantaneous” action takes place. Consider, for example, the illustrative Change Image action. The illustrative Change Image action changes an attribute 402 of the actor 400, and more particularly changes the image rendered to represent the actor. In the example of the arcade-style asteroid game, the Change Image action may change the image rendered to represent rocket action (e.g., flames erupting from the back of the space ship) during periods of time when a key is pressed (e.g., when the key is pressed that initiates acceleration). As yet another example of an action, a Destroy action causes an actor to be removed from the scene. Again in the example of the arcade-style asteroid game, if the space ship actor collides with an asteroid actor, the space ship actor, using the Destroy action, may be removed from the scene.

There are a host of behaviors and actions that may be assigned to an actor in accordance with the various embodiments. Rather than unduly complicate the description by highlighting each behavior and action here, an illustrative list of behaviors and actions is given near the end of this specification in a section titled “BEHAVIORS AND ACTIONS”. The specification proceeds to a more detailed description of the PGF game representation.

PGF Game Representation

In a particular embodiment, the PGF game representation is a plurality of files that define aspects of the game, such as actors, scenes, and images rendered during the game. FIG. 5 shows an illustrative tree structure of a PGF game representation. In particular, FIG. 5 shows a block titled “Example.gameproj” 500. In some cases, the Example.gameproj 500 is a folder or directory of a file system within which the remaining files and directories are stored. In other cases, the Example.gameproj 500 is a theoretical construct used to form the base or root of the tree structure. The balance of the discussion will assume the Example.gameproj 500 is a folder. Within the folder 500 resides a plurality of other folders and files. In the example of FIG. 5, the folder 500 contains five additional folders, comprising the actors folder 502, the scenes folder 504, behaviors folder 506, images folder 508, and sounds folder 510. The illustrative folder 500 also contains files, comprising info file 512, object file 514, and assets file 516.

The info file 512 may contain information regarding the game represented in the PGF game representation, as well as information regarding the version of project editor 100 used to create the PGF game representation. In a particular embodiment, the info file 512 is coded in extensible markup language (XML); however, other coding schemes may be equivalently used, such as JavaScript Object Notation (JSON).

The object file 514 may contain information such as game play instructions, description of the game itself, a list of prototype actors (discussed more below), a list of scenes, as well as initial attributes of the game itself (e.g., name of the game, and display size on which the game will be played). In a particular embodiment, the object file 512 is coded in XML; however, other coding schemes may be equivalently used.

The assets file 516 may contain a manifest of information regarding assets of game, such as a list of sounds, images, behaviors, and actors. Inasmuch as the manifest of information in the assets file 516 may be gleaned by inspection of the other files and other folders, the assets file 516 may be omitted, or created at any time during and/or after game creation. In a particular embodiment, the assets file 516 is coded in XML; however, other coding schemes may be equivalently used.

Within the actors folder 502 resides one or more files, such as the actor files 518 and 520 illustratively titled “1.xml” and “2.xml”, respectively. Each file in the actors folder 502 represents what the inventors refer to as “prototype actor”. Creation of actors within scenes, in accordance with particular embodiments, can be considered a two step process—first, a prototype actor is created, and then an actor is instantiated into a scene based on the prototype actor. However, instantiating an actor instance into the scene does not change or alter the prototype actor. Thus, the prototype actor may be used multiple times as the basis for creating actor instances within a scene. In the example of the arcade-style asteroid game, the game developer may create a prototype asteroid actor. The game developer may then place several asteroid actors into each scene, with each asteroid actor instance being based on the prototype asteroid actor. As will be discussed more below, actors within the scenes can and do behave differently than their prototypes, but the prototype actor forms the initial basis for each actor instance within a scene.

Each actor file within the actors folder 502 contains information about the prototype actor. For example, an actor file may contain information such as the name of the prototype actor, an initial position of the prototype actor, the size of the prototype actor, an initial rotational orientation of the prototype actor, an initial color, an identification of an image which may rendered to represent the prototype actor, an initial linear velocity of the prototype actor, maximum linear velocity of the prototype actor, an initial angular velocity of the prototype actor, and physics-based properties of the prototype actor (e.g., density, friction, and collision shape).

Each prototype actor may also contain indications of the conduct 404 of the prototype actor. That is, each actor file may contain indications of behaviors and actions associated with the prototype actor. Consider again the arcade-style asteroid game. In the example game, the space ship can rotate left or right to “aim” the ship, and can accelerate in the direction pointed by the space ship. To implement such functionality of rotating left or right, and accelerating, an illustrative prototype actor for the space ship combines multiple Rule behaviors with multiple Rotate behaviors. For example, a prototype actor for the illustrative space ship may contain indications as shown in Table 1 below (illustratively coded in XML):

TABLE 1

```
<behavior id=“id901335” class=“RuleBehavior”>
  <attributes>
    <text id=“name”>Rule</text>
    <text id=“bundleName”>Rule.behavior</text>
  </attributes>
  <conditions>
    <condition id=“id762771” eventType=“key”>
      <attributes>
        <index id=“conditionType”>0</index>
      </attributes>
      <predicate type=“key”>
        <attributes>
          <text id=“mode”>down</text>
          <text id=“keyString”>left</text>
        </attributes>
      </predicate>
    </condition>
  </conditions>
  <behaviors>
    <behavior id=“id537732” class=“RotateBehavior”>
      <attributes>
        <text id=“name”>Rotate</text>
        <text id=“bundleName”>Rotate.behavior</text>
        <real id=“angularVelocity”>90</real>
        <index id=“direction”>1</index>
        <boolean id=“halt”>true</boolean>
      </attributes>
    </behavior>
  </behaviors>
</behavior>
```

In particular, the illustrative table shows use of a Rule behavior which sets a rule such that when the left key of the input device is pressed, the Rotate behavior is triggered causing rotation of the actor.

Likewise with respect to rotation in the opposite direction, the prototype actor for the space ship may contain indications as shown in Table 2 below (illustratively coded in XML):

TABLE 2

```
<behavior id=“id973534” class=“RuleBehavior”>
  <attributes>
    <text id=“name”>Rule</text>
    <text id=“bundleName”>Rule.behavior</text>
  </attributes>
  <conditions>
    <condition id=“id472646” eventType=“key”>
      <attributes>
        <index id=“conditionType”>0</index>
      </attributes>
      <predicate type=“key”>
        <attributes>
          <text id=“mode”>down</text>
          <text id=“keyString”>right</text>
        </attributes>
      </predicate>
    </condition>
  </conditions>
  <behaviors>
    <behavior id=“id800946” class=“RotateBehavior”>
      <attributes>
        <text id=“name”>Rotate</text>
        <text id=“bundleName”>Rotate.behavior</text>
        <real id=“angularVelocity”>90</real>
        <index id=“direction”>0</index>
        <boolean id=“halt”>true</boolean>
      </attributes>
    </behavior>
  </behaviors>
  <elseBehaviors />
</behavior>
```

In particular, the illustrative table shows use of a Rule behavior which sets a rule such that when the right key of the input device is pressed, the Rotate behavior is triggered causing rotation of the actor.

Likewise with respect to acceleration of the actor, the prototype actor for the space ship may contain indications as shown in Table 3 below (illustratively coded in XML):

TABLE 3

```
<behavior id=“id694723” class=“RuleBehavior”>
    <attributes>
      <text id=“name”>Rule</text>
      <text id=“bundleName”>Rule.behavior</text>
    </attributes>
    <conditions>
      <condition id=“id868947” eventType=“key”>
        <attributes>
          <index id=“conditionType”>0</index>
        </attributes>
        <predicate type=“key”>
          <attributes>
            <text id=“mode”>down</text>
            <text id=“keyString”>up</text>
          </attributes>
        </predicate>
      </condition>
    </conditions>
  <behaviors>
    <behavior id=“id225772” class=“AccelerateBehavior”>
      <attributes>
        <text id=“name”>Accelerate</text>
        <text id=“bundleName”>Accelerate.behavior</text>
        <angle id=“direction”>90</angle>
        <index id=“space”>0</index>
        <real id=“acceleration”>100</real>
      </attributes>
    </behavior>
  </behaviors>
</behavior>
```

In particular, the illustrative table shows use of a Rule behavior which sets a rule such that when the up key of the input device is pressed, the Accelerate behavior is triggered causing acceleration of the actor.

Within the scenes folder 504 resides one or more files, such as the file 522 and 524 illustratively titled “1.xml” and “2.xml”, respectively. In a particular embodiment, each scene of the game has a respective file in the scenes folder 504. Thus, a first scene of the game may be represented by the scene file “1.xml”, a second scene of the game may be represented by the file titled “2.xml”, and so forth. However, in other embodiments the scenes may be contained in a single file. Each scene file contains a host of information about the scene. For example, the illustrative scene file 522 may contain information such as the name of the scene, window size for the scene, an indication of whether the scene wraps at the edges (e.g., whether an actor that moves out of the scene to the right re-appears on the left as if the space is connected along the vertical edges), an indication of the location to which acceleration due to gravity should be directed, initial color of the scene, initial camera location, initial window size for the camera, and (for portable devices) whether the scene should rotate as the device is rotated. In a particular embodiment, the information within scene file 522 is coded in XML; however, other coding schemes may be equivalently used.

The information regarding a scene may comprise more than just the set of initial information discussed in the previous paragraph. In some embodiments, a scene may have several “layers” within which actors may be placed. The layers do not necessarily imply depth, just a logical relationship for rendering the actors—in some cases actors at higher layers are rendered over actors at lower layers. For example, in the illustrative arcade-style asteroid game, the game designer may want to create what appears to be a distant planet in the scene for visual purposes. To implement such visual scene, the game designer may place a planet actor in one layer, and then the space ship actor and asteroid actors in a “higher” layer such that the space ship actor and asteroid actors are rendered over the planet actor.

In addition to the information about the scene discussed above, each scene file may also contain information about the actor instances within the scene. As discussed above, each actor instance within a scene is based on a prototype actor. Each actor instance within a scene initially has all the attributes 402 and conduct 404 of its respective prototype actor, but the actor's attributes and conduct may change during the game, and the changes in attributes and conduct are not reflected in changes to the respective prototype actor. Consider again the example arcade-style asteroid game and prototype space ship actor. The prototype space ship actor may have an initial position. For example, the actor file (in the actors folder 502) for the prototype space ship may contain the initial position information shown in Table 4 (coded in XML):

TABLE 4

```
<actor id=“id653439”>
  <attributes>
    <text id=“name”>SpaceShip</text>
    <real id=“time”>0</real>
    <point id=“position”>
      <real id=“x”>0</real>
      <real id=“y”>0</real>
    </point>
    <size id=“size”>
      <real id=“width”>64</real>
      <real id=“height”>64</real>
    </size>
    <angle id=“rotation”>0</angle>
    <color id=“color”>
      <real id=“red”>1</real>
      <real id=“green”>1</real>
      <real id=“blue”>1</real>
      <real id=“alpha”>1</real>
    </color>
    <text id=“image”>ship-paper-64×64.png</text>
    <text id=“tags” />
    </attributes>
```

Thus, the prototype actor named “SpaceShip” has an initial state (e.g., position, size, rotational angle, color, and designated image).

However, within a scene a game designer may want to have a different initial position. In order to instantiate the space ship actor in the scene, the instantiation from the prototype space ship actor, the scene file may contain a reference to the prototype actor, and also any change of attribute or conduct the particular instantiation should implement. For example, the scene file (in the scenes folder 504) may contain information such as shown in Table 5 (coded in XML):

TABLE 5

```
<scene id=“id269551”>
  <layers>
    <layer id=“id112326”>
      <actors>
        <actor id=“id695059” prototype=“id653439”>
          <attributes>
            <point id=“position”>
              <real id=“x”>236</real>
              <real id=“y”>165.5</real>
            </point>
          </attributes>
          <aspects />
        </actor>
      </actors>
    </layer>
  </layers>
```

In particular, in this example portion of a scene file, actor instance having “id695059” is based on prototype actor “id653439” (i.e., the prototype SpaceShip actor from Table 4). Both Table 4 for the prototype SpaceShip actor and Table 5 have an entry “point id=‘position’”, but have different values. Thus, the actor instance rendered in the scene based on Table 5 will have or inherit all the attributes and conduct of the prototype SpaceShip actor, but the position information will be overridden by the data in the scene file. As an aside, in the illustrative portion of the scene file shown in Table 5, the actor is placed within a particular layer (i.e., layer identified as “id112326” in this example). If additional actor instances are present with the scene, each actor instance will have an entry in the scene file at the respective layer, and will further include information to indicate changes of attributes or behaviors from those of the prototype actor upon which the actor is based.

Still referring to FIG. 5, within the images folder 508 reside various images that are or may be used during game play. More particularly, the images that are rendered are stored in the images folder 508. For example, the images folder 508 may store a bitmap image of a space ship that is identified as the image with respect to a space ship actor in a scene. As yet another example, the images folder 508 may contain the successive images used by the Animate behavior.

Within the sounds folder 510 reside various sound files that are or may be used during game play. For example, the Play Music action may play a sound file stored in the sounds folder 510. Likewise, the Play Sound action may play a sound file stored in the sounds folder 510.

Within the behaviors folder 506 may reside a file system element 526 illustratively titled “1.behavior”. In a particular embodiment, behaviors and/or actions may be grouped to form pre-packaged behavior sets or behavior bundles. The prepackaged behavior sets may then be quickly and easily applied to prototype actors, or to actors instantiated within a scene. In these embodiments, the behavior bundles may be stored within the PGF game representation in the behaviors folder 506. In some cases, the illustrative “1.behavior” file system element 526 may be a file, coded in any suitable format, that defines the behavior bundle. In other cases, the illustrative “1.behavior” file system element 526 is a folder within which other files and folders may reside. For example, in the case where file system element 526 is a folder, the folder may contain files such as an information file 528, object file 530, and assets file 532. These files may perform a similar function to the info file 512, object file 514, and assets file 516 discussed above, but directed to the particular behavior bundle rather than the entire game. The files 528, 530, and 532 may be coded in any suitable form, such as XML. Moreover, where the file system element 526 is a folder, the actors folder 534, images folder 536, and sounds folder 538 may perform a similar function as the actors folder 502, images folder 508, and sounds folder 510 discussed above, but limited to the particular behavior bundle rather than the entire game.

A few points should be highlighted before proceeding. While it is possible for a game developer to manually code the use of any of the attributes, as well as any of the behaviors and actions noted in the section below titled “BEHAVIORS AND ACTIONS”, in accordance with at least some embodiment the game developer creates the game by interaction with a graphical user interface of the project editor in a drag and drop style (e.g., a prototype actor is drug and dropped into a scene, thereby instantiating the actor in the scene based on the prototype actor). Thus, in a particular embodiment it is the programs that implement the project editor 100 that create and manipulate the files noted with respect to the PGF game representation. Next, the illustrative XML in the tables above are not executable code and shall not be considered source code. However, when read by an execution engine, the PGF game representation is all that the runtime engine needs to implement the behaviors and actions of the actors within the scenes. The specification now turns to various graphical user interfaces of the project editor 100.

Project Editor

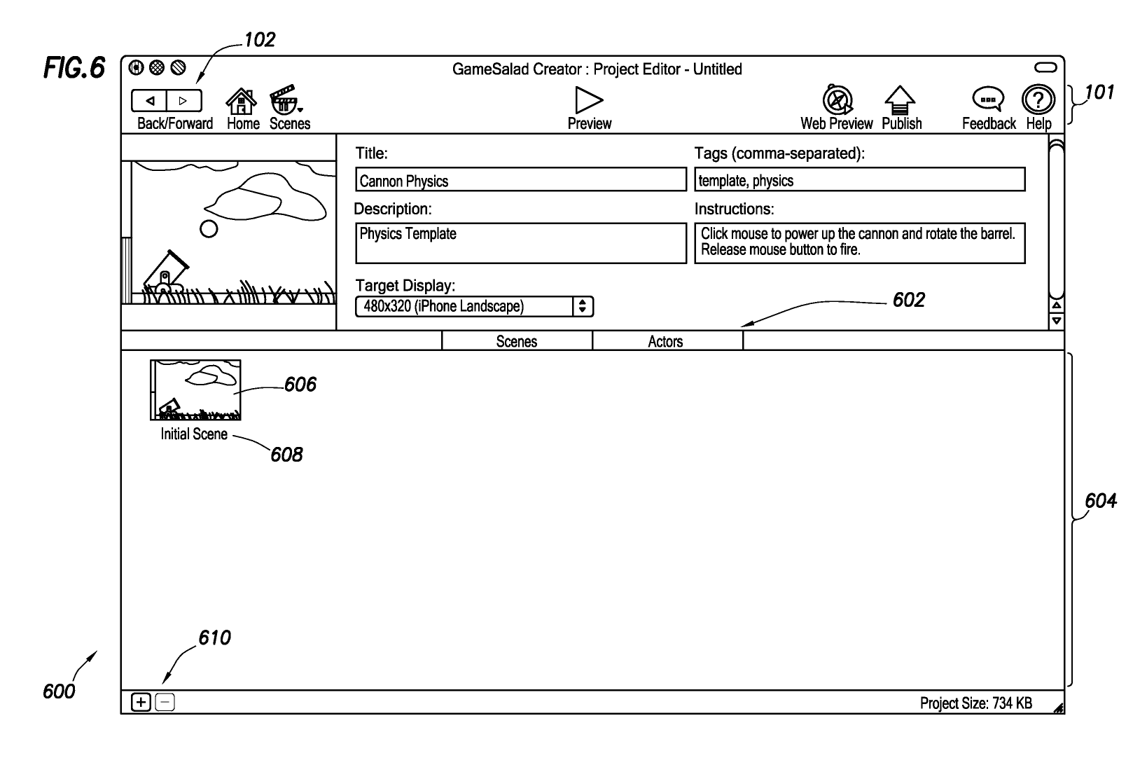

In accordance with particular embodiments, game development takes place by interaction with a series graphical user interfaces. The discussion begins with the project editor view. The first view a game developer may see when using the application is the project editor view 600 as shown in FIG. 6. The project editor view 600 provides a location to supply descriptive data about project including the project name, a description, categorical tags, icon or screenshot. The descriptive information helps the game developer identify a given game upon first viewing, and also can be submitted when the application is subsequently published to an online catalog or store. Below the descriptive information is a tabbed interface 602 that enables game developers to select between managing scenes and/or actors.

When the scene manager tab 604 is visible, game developers can see screenshot thumbnail images that represent the scene, such as screenshot 606, or if no screenshot thumbnail image has been designated a generic icon. The game developer may edit the scene's name by clicking on a textual label 608 below the screenshot 606. If a game developer double clicks on the screenshot thumbnail image of scene, the interface switches to the scene editor view, discussed more below. At the bottom of the project editor view 600 are two buttons 610 labeled with plus and minus signs. The buttons 610 enable the game developer to add new scenes or to remove the selected scenes.

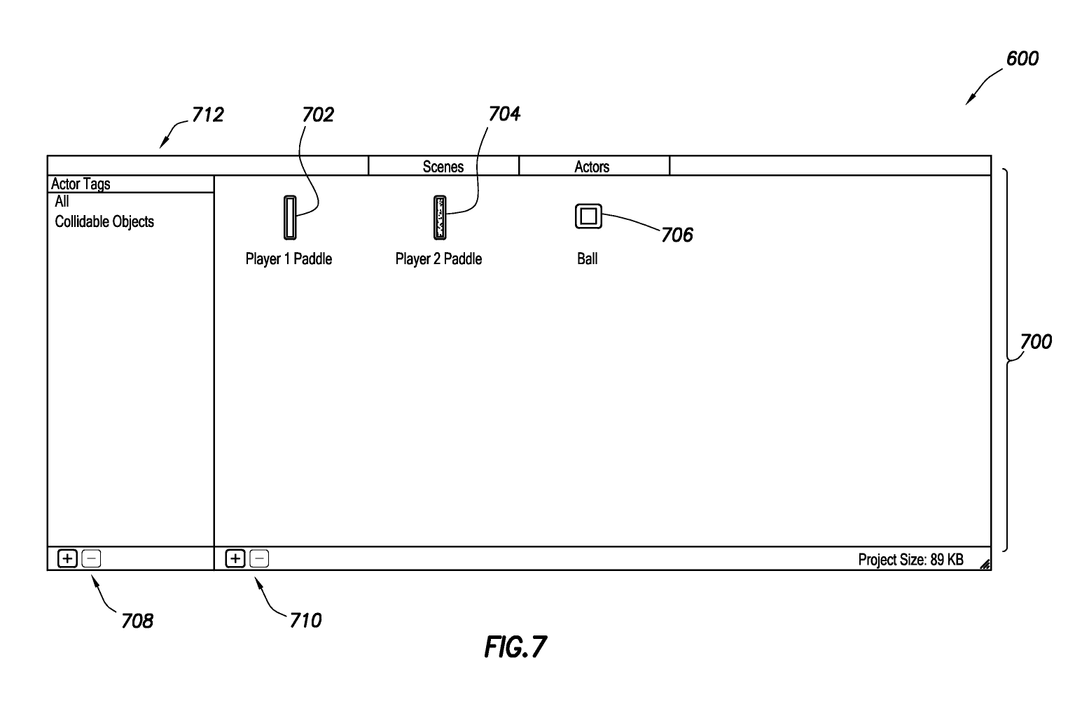

FIG. 7 shows a portion of the project editor view 600 when the actor manager tab 700 is visible. In particular, when the actor manager tab 700 is visible, a game developer sees thumbnail images for each prototype actor. In the illustrative case of FIG. 7, the thumbnail images include prototype actors used in a table tennis-style game, such as images 702 and 704 showing paddles, and image 706 showing the ball. Similar to scene manipulation, a game developer may edit the name of a prototype actor or edit the actor itself by double clicking on the thumbnail image to switch to the actor editor view, discussed more below. At the bottom of the interface are two sets of buttons 708 and 710, each set of buttons comprising a plus sign button and minus sign button. The sets of buttons 710 enables the game developer to add new or remove actors. The sets of buttons 708 enables the game developer to add new or remove tags.

In at least some embodiments, a game developer may label actors with any number of optional tags. By default, a game developer will see all actors in a game project at once. Displaying all the actors in a game project may display too much information for efficient navigation. By applying tags, the actors can be grouped and categorized. When one or more actor tags are selected in the actor manager tab 700, the actor list is filtered to only display actors containing the selected tags, making the actor list easier to manage and navigate. Selecting the display of all actors, or only actors with certain tags, may be made within the tag selection window 712.

Tags may also be used with behaviors to define collision groups. For example, a Collide behavior may be associated with a series of actors, and the group to which the collisions are evaluated may be selected based on an actor tag. Consider again the arcade-style asteroid game with the distant planet in the background. The space ship actor and asteroid actors may be assigned with a common tag, like “CollisionGroup”, and the distant planet could be assigned a different tag, like “NonCollisionGroup”. In assigning behaviors to the space ship actor and asteroid actors, the Collision behavior can be set to apply only to actors tagged with the “CollisionGroup” tag, and thus the distance planet will be “involved” in the collisions between the space ship actor and the asteroid actors. The specification now turns to the scene editor.

Scene Editor

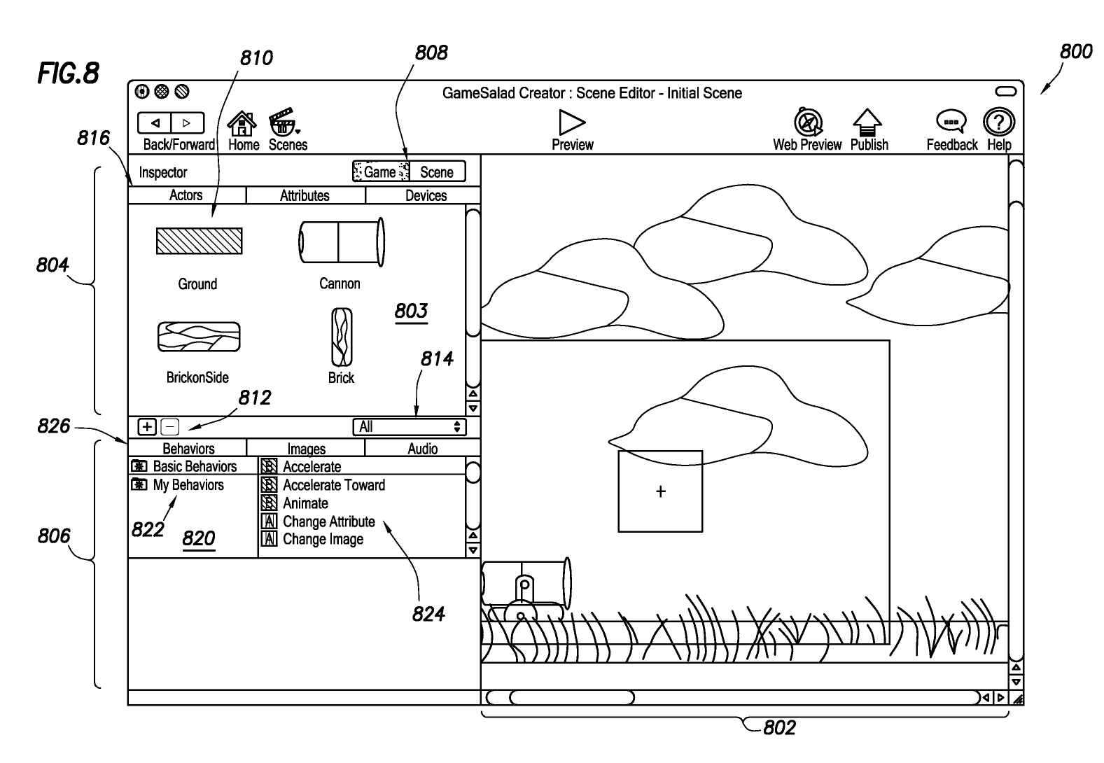

Another view a game developer may see is the scene editor view 800 as shown in FIG. 8. In particular, the scene editor view 800 enables the game developer to layout the initial position of actor instances in the scene, set how the view port or camera is controlled, and preview and interact with the scene by way of the runtime engine 104 associated with the project editor 100. Runtime interaction enables a game developer to have a more tactile feel for how the game runs, as well as enabling testing of the interactions of actors with other actors in the scene. Notable areas of the scene editor view 800 are the scene area 802, the inspector area 804, and media browser 806.

The inspector area 804 of the scene editor view 800 is where a game developer interacts with the working elements of the scene. There are two illustrative groupings—views related to the game as a whole, and views related to the scene. The two views can be accessed by clicking respective buttons 808 that enable switching of modes.

When the game button of buttons 808 is selected, the game developer may see actor pane 803 in the inspector area 804, as shown in FIG. 8. The actor pane 803 shows thumbnail images of the actor instance and the actor's label, such as actor and label indicated at 810. At the bottom left of the pane there are plus and minus buttons 812 that enable the game developer to add new actor instances or delete the selected actor, respectively. On the bottom right there is a drop down dialog box 814 that enables the game developer to choose from the existing tags in the system. Selecting a tag in the dialog box 814 filters the actor list, displaying only actors which contain the selected tag.

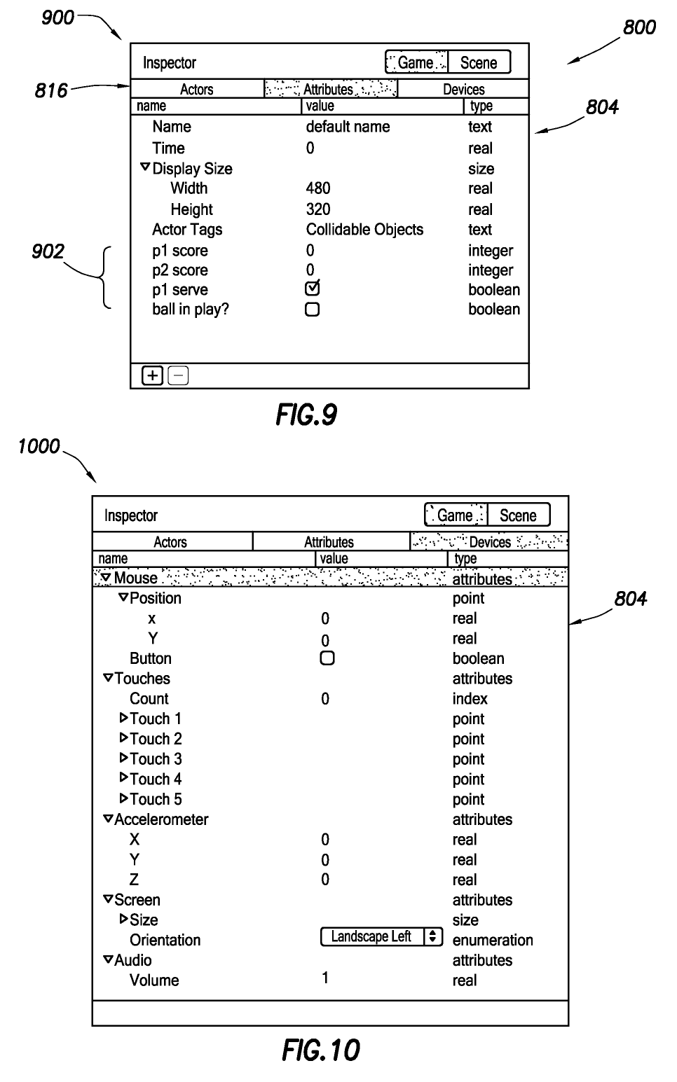

The inspector area 804 may also show a game attributes view, where selecting between the views involves interaction with buttons 816. FIG. 9 shows the inspector area 804 of the scene editor view 800 when the inspector area 804 shows the game attributes view 900. In particular, the game attributes view 900 enables the game developer change attributes that apply to the whole game, as well as add new attributes 902 that can be used to store and share data during runtime.

Referring again to FIG. 8, the inspector area 804 may also show a game devices view, where selecting between the views again involves interaction with buttons 816. FIG. 10 shows the inspector area 804 of the scene editor view 800 when the inspector area 804 shows the game devices view 1000. In a particular embodiment, the game devices view 1000 gives a readable representation of the state of input and display hardware. For example, the game devices view 1000 may provide information such as current position of the mouse, last position of touch on the touch screen, current audio volume. In some cases, the game devices view 1000 does not enable changing of the values displayed.

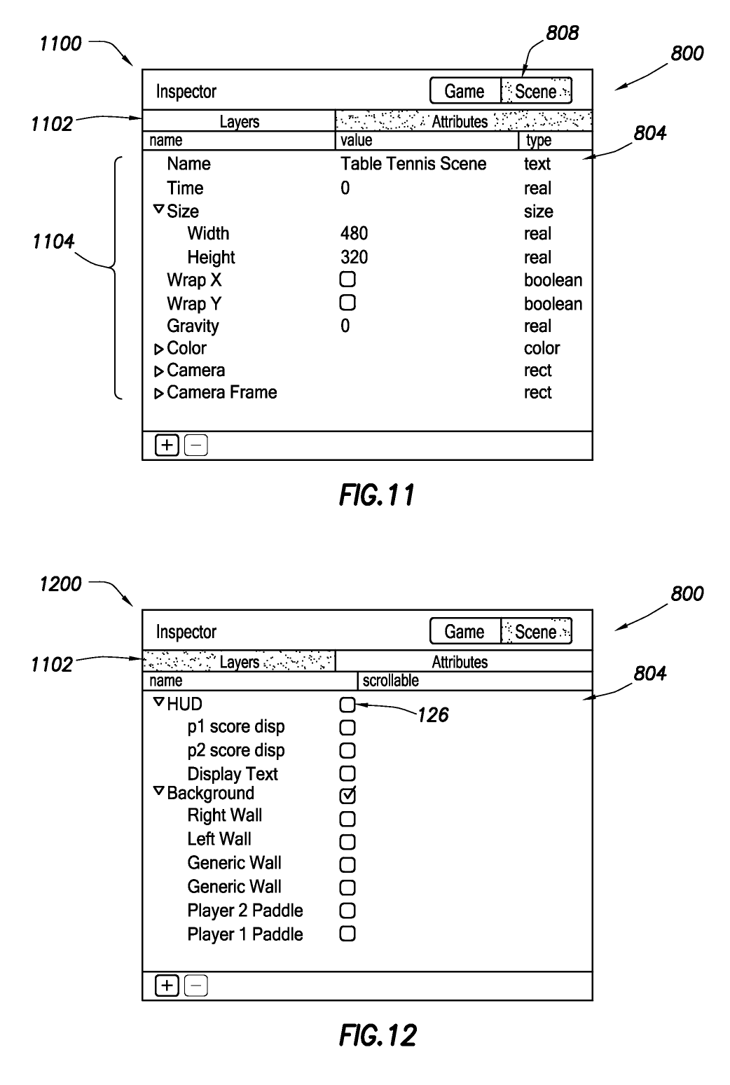

Referring again to FIG. 8, in addition to the scene views discussed above for the inspector area 804, the inspector area 804 may also show scene attribute information, where selecting between the views again involves interaction with buttons 816. FIG. 11 shows the inspector area 804 of the scene editor view 800 when the inspector area 804 shows the scene attributes view 1100. In a particular embodiment, the scene attributes view 1100 is accessed by interacting with buttons 1102. The scene attributes view 1100 enables the game developer to set scene attributes by interaction with area 1104. Illustrative attributes comprise, for example, scene name, scene size, default background color.

FIG. 12 shows the inspector area 804 of the scene editor view 800 when the inspector area 804 shows the scene layers view 1200. In a particular embodiment, the scene layers view 1200 is accessed by interacting with buttons 1102. The scene layers view 1200 enables the game developer to manage the display order of actors in a scene. The order of actors in the layers determines the order in which overlap when drawn on the screen. Objects higher in the layer list (or alternative closer to the point of view) are displayed above objects lower in the list. A scene can have multiple layers, and objects in a higher layer are drawn above objects in a lower layer. Each layer has the option of being “scrollable”. In a non-scrollable layer, actors maintain their positions relative to the camera viewport's coordinate space. That is, if the camera viewport moves, actors move along to maintain the relative position in the viewport. If the layer is scrollable, the actors move relative to the scene's coordinate space. That is, if the camera moves, the actor will seem to move independently of the camera.

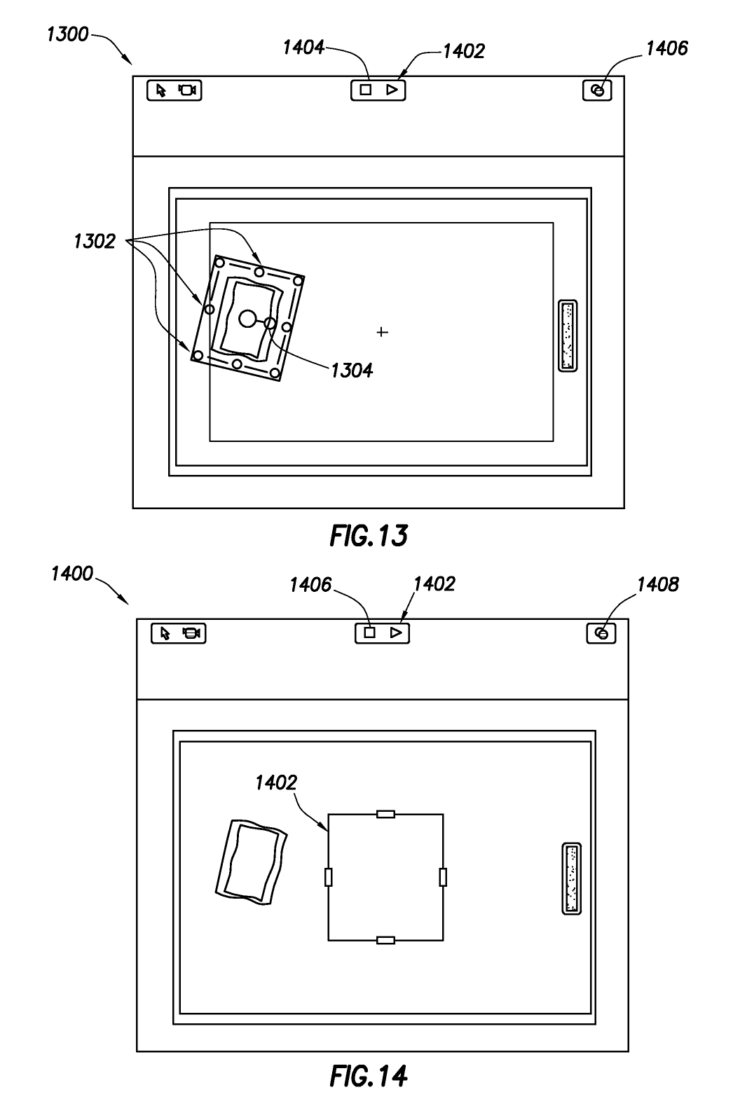

Referring again to FIG. 8, the next illustrative area is the scene area 802. Scene area 802 enables the game developer to visualize information such as the relative position of actors in a scene, the size of the camera viewport, and to preview how the scene acts during runtime. The scene area has two modes—layout mode and camera mode. The default mode of the scene area 802 is the layout mode. FIG. 13 shows the scene area 802 when the scene area 802 is set for layout mode. In particular, layout mode 1300 enables a game developer to position actors within the scene and manipulate the actors. To add actors to the scene, the game developer drags the actors from the actor pane 803 (FIG. 8) and places the actor within the scene. The user may then manipulate actors by, for example, moving the actors, stretching their width and height 1302, or by changing rotation 1304 of the actors.

The second mode of the scene area 802 is camera mode. FIG. 14 shows the scene area 802 when the scene area 802 is set for camera mode 1400. In particular, during runtime an actor may be assigned control of the camera. Control of the camera means that the camera will follow wherever the actor moves. The camera mode 1400 view enables the game developer to edit the dimensions of the camera's tracking area. When an actor reaches an edge of the tracking area 1402, the camera will move to keep the actor within the tracking area's boundary.

In either mode of the scene area 802, the game developer may execute the game for a given scene by pressing the play button 1404 and stop and reset execution by pressing the stop button 1406. During execution, the game developer may continue to adjust the size and rotation of an actor, or add new actors, to see how the game transpires. By default, the scene area 802 displays a translucent version of the actors during execution to indicate the actor's initial position. Translucent operation enables the game developer to discern how an actor moves as the game is executed. The game developer may toggle the translucent functionality by pressing the initial state display button 1408.

Referring again to FIG. 8, the final element of the scene editor view 800 is the media browser 806. The media browser 806 has three views—behaviors view, images view, and audio view. The default view for the media browser 806 is the behaviors view 820 as shown in FIG. 8. The behaviors view 820 has several parts, such as behavior folders 822, the behavior (and actions) list 824, and in some cases a documentation pane that gives a brief explanation of each behavior and/or action. The behavior folders 822 section enables a game developer to select from either a set of behaviors provided by the game development system, or custom behaviors which the game developer has created. Depending on the folder selected, the appropriate set of behaviors are in the behavior list 824. In the scene editor view 800, a game developer may drag a behavior onto an actor in either the scene area 802 or the actor view 803 of the inspector area 804. Dragging the behavior to the actor changes default attributes and conduct of the actor. If the scene is executing in the runtime preview, the behavior will begin to take effect immediately.

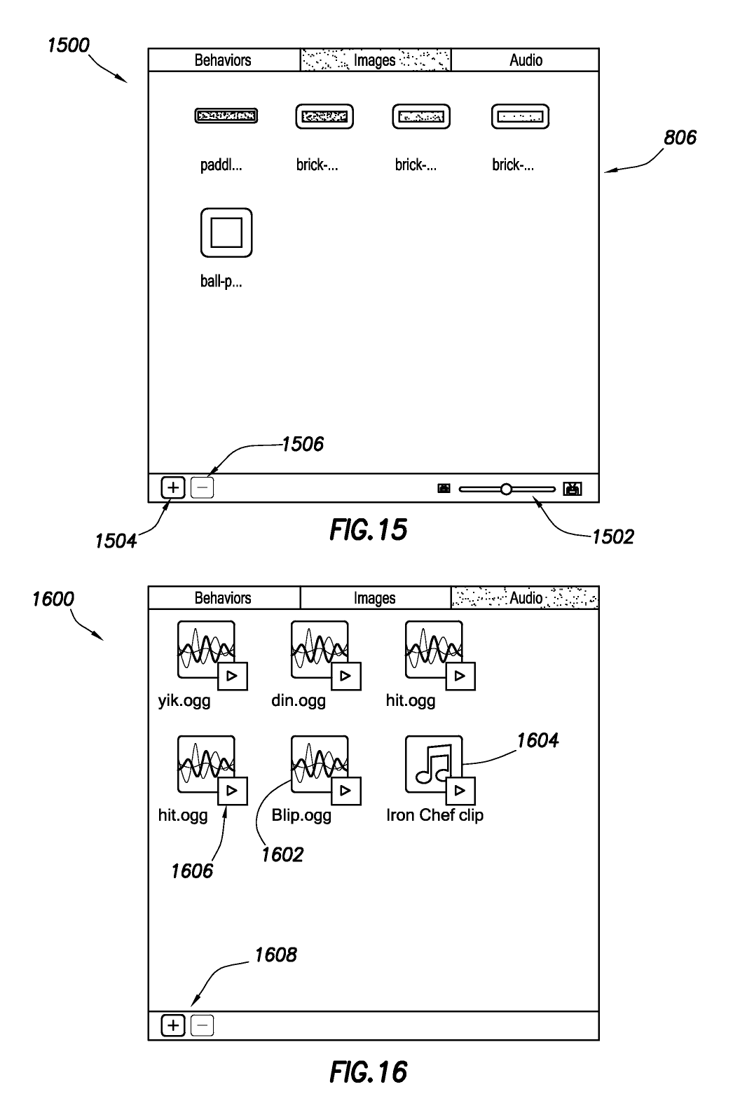

Another view within the media browser 806 is the images view. The game developer may select the image view in the media browser 806 by interaction with buttons 826. FIG. 15 shows the media browser 806 when the media browser 806 is set for the image view. In particular, in the image view 1500 may display thumbnail images of all the images that have been imported into the game development system. The game developer may change the size of the thumbnail icons by moving a slider 1502. Moving the slider left may make the thumbnail images smaller and moving the slider to the right may makes the thumbnail images larger. To add more images game developer may either drag image files from the operating system's file browsing environment, or the game developer may click on the plus button 1504, which displays a file selection dialog box. In some embodiments, image files added are automatically converted to a format acceptable to the runtime engine 104 (and illustrative runtime engines 200, 202, and 204). Images may be dragged onto actors to set the actor's image, or on to the scene in the scene area 802. If a user drags an image onto the scene, a new actor will be created with the image set as the actor's image. If an image is selected and the minus button 1506 is clicked, the image will be removed from the project.

Another view within the media browser 806 is the audio view. The game developer may select the audio view in the media browser 806 by interaction with buttons 826. FIG. 16 shows the media browser 806 when the media browser 806 is set for the audio view. In particular, audio view 1600 enables the game developer to manage sounds and music by adding and removing the sounds and/or music from the project. In the audio view 1600, the media browser may display icons that indicate whether the audio is a sound file (e.g., such as by icon 1602) or a music file (e.g., such as by icon 1604). The two file types are not differentiated by format but rather their usage by the runtime engine 104. Music files may be streamed from storage and, in some cases, can only be played one at a time. Sound files are buffered in memory, and can be mixed so that multiple sounds may be played at the same time. The game developer may also preview sounds by clicking on the play button 1606 to play the sounds. Consistent with behavior within other views, the game developer may use the plus and minus icons 1608 to add more sound files or to remove the selected sound file, respectively. In some embodiments, music files added will automatically be converted to formats acceptable to the runtime engine 104. The game developer may also add new audio files by dragging them from the operating system's file browsing environment.

As discussed above with respect to prototype actors, the runtime engine 104 uses an inheritance model for actors. Each actor instance has one prototype, and a prototype may have many actor instances. By default an actor behaves as defined by its prototype actor. A particular instance of an actor may also be changed so that it behaves differently from the prototype actor. In accordance with at least some embodiments, when a user double clicks on an actor icon in the actor pane 803 of the inspector area 804, an actor editor view (discussed more below) displays attributes and/or conduct of the prototype actor. If game developer double clicks on an actor instance in the scene, the game developer may then be presented with a prompt to perform a positive action to unlock (or de-couple) the behaviors of the actor instance from the prototype actor. By unlocking the behaviors of an actor instance, the game developer overrides the prototype actor behavior and is free to modify the behaviors of the actor instance directly. From that point on, edits to prototype's behaviors with respect to overridden behaviors (or actions) will no longer affect the actor instance. If game developer chooses to discard the custom behavior in favor of the prototype actor behavior, the game developer may click on a button to “Revert to Prototype”. Reverting to prototype “re-locks” the actor instance's behaviors (and actions) to those of prototype actor from which the instance was created. The same prototype system also applies to attributes. Actor attributes are inherited from the prototype actor. If the game developer changes an attribute of an actor instance, it will become overridden and no longer inherit values from the prototype.

Actor Editor View

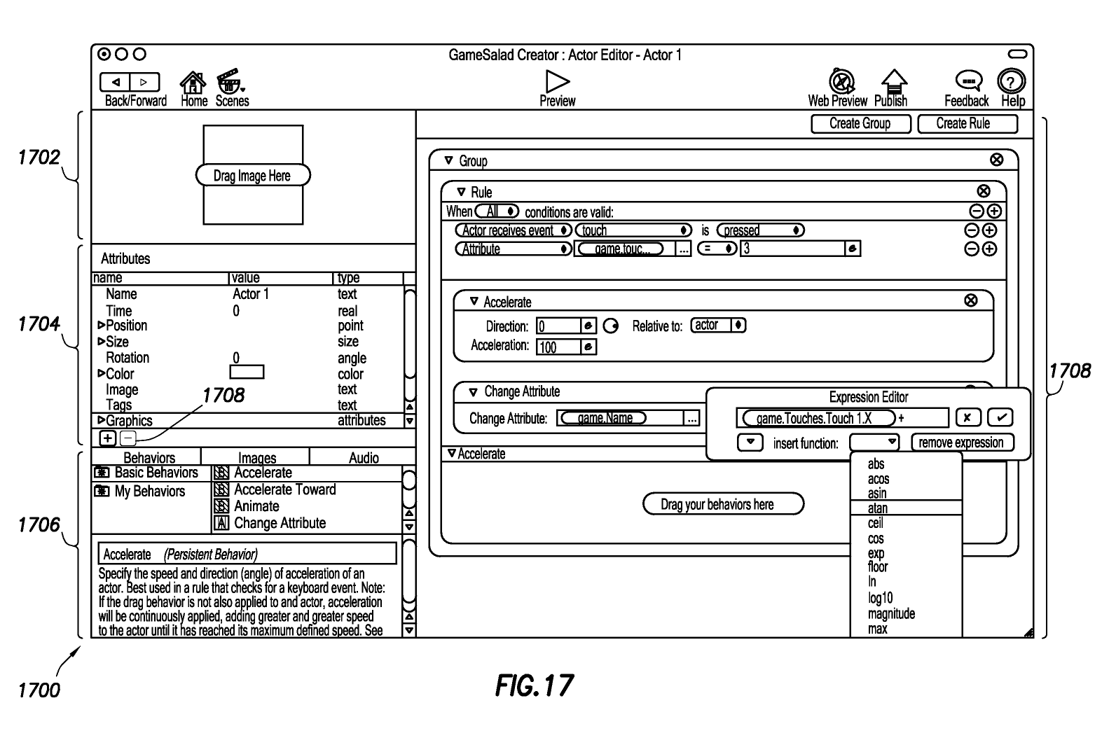

FIG. 17 shows an actor editor view 1700 of the project editor 100. The actor editor view 1700 is composed of four main panes—image pane 1702, the attributes pane 1704, the media browser pane 1706, and the behavior composer pane 1708. If the game developer is editing an actor instance, in addition to the illustrative panes shown in FIG. 17, three additional buttons appear: “Edit Prototype”, which enables the game developer to edit the instance's prototype; “Revert to Prototype”, which reverts the behaviors/actions of the actor instance to that of its prototype actor; and “Revert to Prototype”, which reverts a selected attribute back to the prototype actor.

Image pane 1702 displays a thumbnail image of the actor being edited, if an image has been associated with the actor. In cases where no image has been associated with the actor, such an associated may be made by dragging a selected image to the image pane 1702.

Attributes pane 1704 enables the game developer to edit the attributes of an actor, as well as add and remove custom attributes for the actor by pressing the plus and minus buttons 1708. Actors have a number of attributes which specify how they are displayed and behave as previously discussed.

The attributes of an actor also include special groups of attributes the inventors have termed “aspects.” Aspects may help organize certain attributes into groups which provide functionality that may be shared by multiple behaviors. Attributes of an illustrative graphics aspect may determine whether an actor is visible during runtime, how the actor blends with other actors, and how the image of the actor is rendered inside the actor's space. For example, an actor may have its image stretched fit the actor's width and height. Other illustrative attributes include a physics aspect. If the physics aspect is turned off, the actor will not be given a representation in the physics engine. In other words, aspects are the mechanisms by which an actor can be given capabilities which are shared by multiple behaviors (i.e., multiple accelerate or collide behaviors acting on the physics state of an actor). Aspects also play a role in optimization of program execution (e.g., invisible actors do not get drawn, immovable actors do not get simulated, and the like).

Attributes of an illustrative motion aspect may specify the actor's initial motion, and constraints on the maximum allowable motion. During runtime a behavior may modify an actor's velocity, limit the actor's maximum velocity, and change the actors angular velocity. A rule or behavior may also to read attributes such as maximum velocity and angular velocity during runtime.

Attributes of an illustrative physics aspect may specify how the actor interacts with the physics engine of the runtime engine. Examples of such attributes are the actor's density, friction, restitution, and collision shape.

The media browser pane 1706 works much like the media browser pane 806 of the scene view editor 800. While behavior of the media browser pane 1706 may be no different than the media browser pane 806, the actor editor view 1700 presents different locations to which the behaviors (and actions) can be associated.

Within the actor editor view 1700 the behavior and actions of an actor are defined, specifically within the behavior pane 1708. In accordance with some embodiments, attaching a behavior (or action) to an actor may involve dragging the icon for a behavior from a list of behaviors in the media browser pane 1706 into the behavior pane 1708. Furthermore, if the game developer drags media icons from the media browser pane 1706 (e.g., images, audio) the project editor adds an appropriate behavior that matches the media. For example, if a game developer drags an image from the media browser pane 1706 to the behavior pane 1708, the project editor automatically adds a Change Image behavior to the actor. If a game developer drags a group of images from the media browser pane 1708, the project editor add an Animate behavior. Likewise for audio assets, if game developer drags a sound or music asset from the media browser pane 1706, the project editor creates a Play Sound or Play Music behavior, respectively. Upon dragging any of such elements on to the behavior pane 178, the declarative representation of the behavior appears, as well as indicators as to where the behavior will be placed when the mouse is released.

In accordance with at least some embodiments, game flow or design is only defined in the context of an actor. Thus, a game designer declares that an actor behave a certain way by dragging a behavior and/or action from the behavior tab of the media browser pane 1706 into the behavior pane 1708. If a particular behavior is dragged into the top level of the behavior pane 1708, the particular behavior will evaluate at the start of runtime execution of the actor.

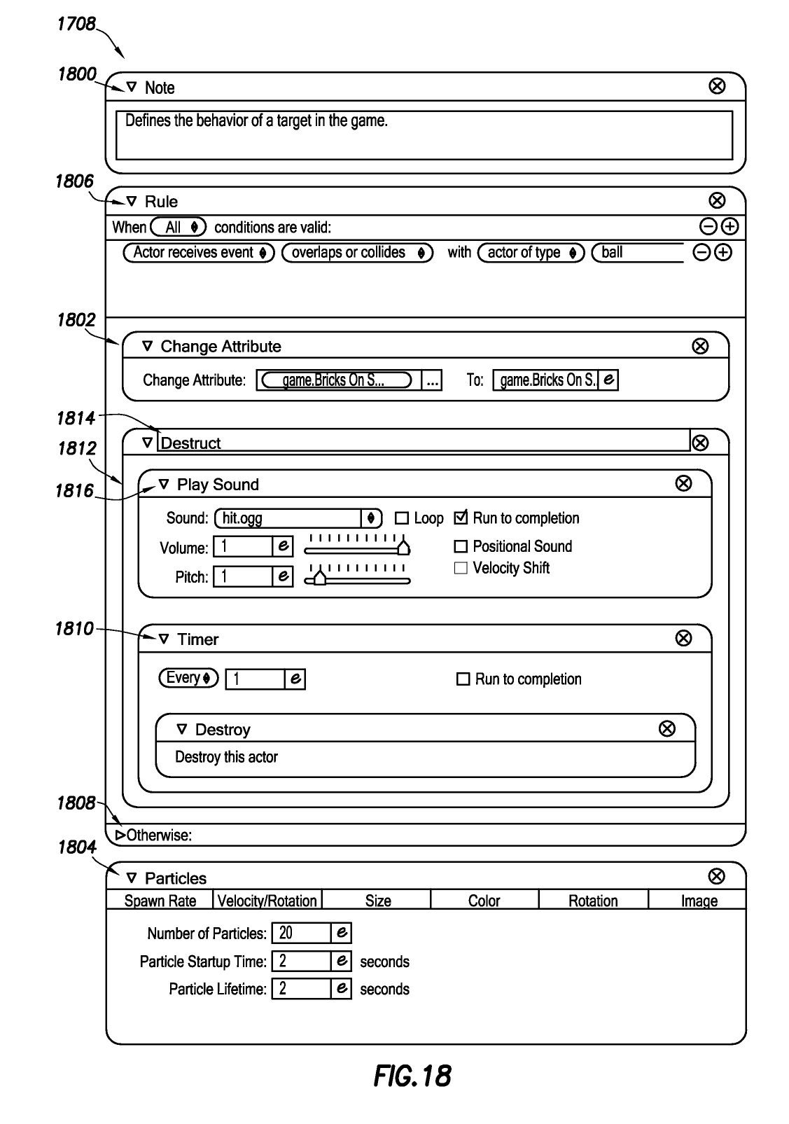

FIG. 18 shows an illustrative behavior pane 1708 in accordance with at least some embodiments. In particular, the illustrative behavior pane 1708 comprises a Note behavior 1800, which Note behavior does not result in action on the part of the actor, but may be thought of as a “container” for keeping notes about other behaviors and/or actions. Actors can be directed to take one time actions, such as the Change Attribute action 1802, or directed to act in a certain way persistently, such as the Particles behavior 1804.

In further situations, a game developer may want an actor to act according to certain behaviors and/or actions only after certain runtime conditions are met. To achieve the condition-based behaviors and/or actions, a Rule behavior may be used, as illustrated by Rule behavior 1806. The interface elements for Rule behaviors enclose other behaviors and/or actions that are subject to the rule. The Rule behavior enables a game developer to define runtime conditions such as attribute values and events to trigger the evaluation of behaviors within the rule. When basing a condition on attributes, the various embodiments provide the correct comparison operators for the data type of the attribute. For example, if an attribute is a Boolean, the Boolean attribute can only be compared to true and false. If the attribute is a numeric, the numeric attribute can only be tested using numeric comparison operators such as > (greater than) or = (equals). The game developer may also define an actor's behavior if the rule's conditions are not met by way of an “otherwise” block, such as shown at 1808. The illustrative Timer behavior 1810 enables set of other behaviors and/or actions to be run based on time. The group of behaviors enclosed in a Timer behavior may run after a specified period of time, triggered repeatedly between a specified time interval, or run one time for a specified amount of time.

Another behavior that does not affect the actor during runtime, but enables the game developer to better organize behaviors, is the Group behavior 1812. In particular, the illustrative Group behavior enables a game developer to encapsulate behaviors into groups. In the illustrative case of FIG. 18, a Group behavior 1812 is used to group the Play Sound action and the Timer behavior. The game developer may also change the label of a behavior by double clicking on the behavior's label 1814. Changing a label enables a game developer to document the intent of the declaration. In the case of FIG. 18, the Group behavior 1812 label is illustratively changed to “Destruction”.

As an example of how behaviors work, FIG. 18 illustrates behaviors for an illustrative destructible brick in a game. At the top, Note behavior 1800 provides documentation about this particular actor. At the bottom, Particle behavior 1804 implements a persistent behavior that continuously emits particles from the actor. The actor also contains a Rule behavior 1806 which activates behaviors when the actor collides or overlaps with another actor called “ball”. If the condition of the Rule behavior 1806 is true, an application attribute (i.e., game.Bricks in this example) is decremented using the Change Attribute action 1802. At the same time the Play Sound action 1816 is executed which plays the sound “hit.ogg” with no changes to volume or pitch. Also as illustrated, the Timer behavior 1810 is set to trigger the Destroy action with respect to the actor every one second.

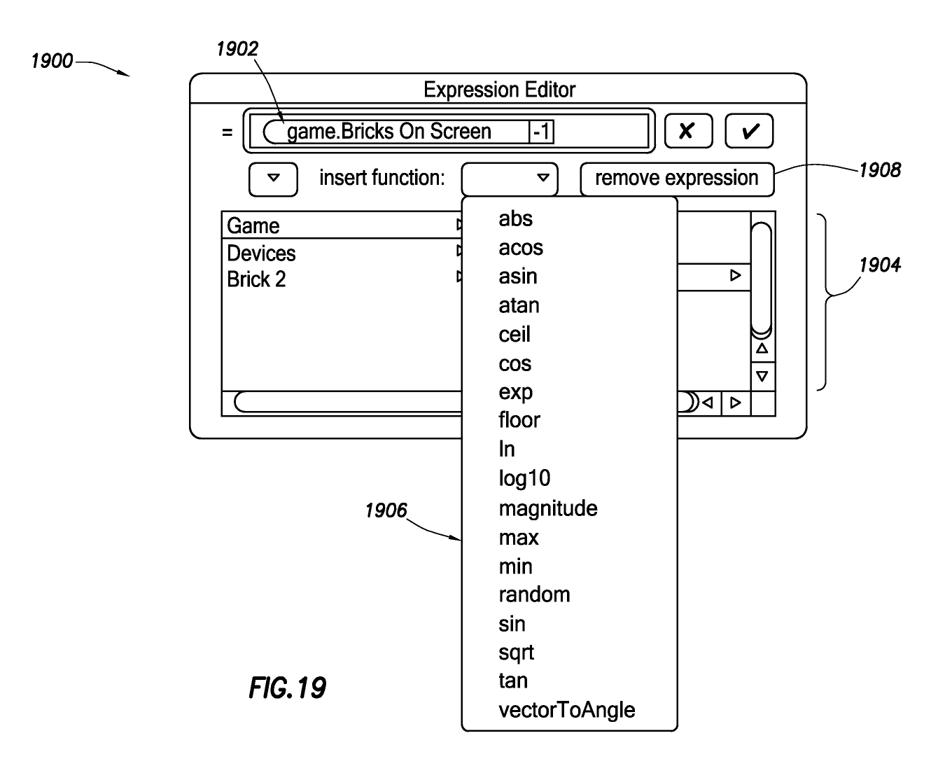

In accordance with particular embodiments, some behaviors and/or actions can accept mathematical expressions as parameters, which enable the game developer to create more complex logic. To help the game developer enter well formatted expressions, the project editor 100 provides an expression editor. FIG. 19 shows an illustrative view of the expression editor 1900 in accordance with at least some embodiments. In particular, the expression editor has an expression field 1902 which holds the completed expression. An attribute browser 1904 shows various attributes, and in some embodiments makes available for selection only attributes that can be logically combined to create the expression. Additionally, the expressions may also contain mathematical functions as shown in the illustrative drop-down menu 1906. Some embodiments also implement remove expression function 1908, which reverts a behavior and/or action parameter into a fixed value.

Preview Mode View

When game developer wishes to execute the game, the game developer enables a preview mode. If the game developer enables the preview mode while in the scene editor view 800, the particular scene being edited executes. In other cases, the preview begins executing the first scene. In the preview mode the interface shows the application running in its final viewport size. In the preview mode the user may also change to running a specific scene by choosing the scene from a scene listing. The game developer may also take screenshots of the game in the preview mode. The screenshot dialog appears and gives game developer the option to save the screenshot to disk, set the screenshot as the main screenshot for the project, or to set the screenshot as the screenshot representing the scene in scene listings.

Project Editor and PGF Game Representation

Before continuing, it may be helpful to an understanding of the various embodiments to highlight particular relationships of the portions discussed to this stage. In particular, the specification discussed the PGF game representation 102, and the project editor 100 (in particular, various scene and actor views), and it is to be understood that actions that take place in the graphical environment of the project editor 100 result in changes and additions in the PGF game representation. For example, if by way of the actor editor 1700 a game developer creates a Rule behavior to receive keyboard inputs and a Rotate behavior to cause rotation of a prototype actor based on the keyboard inputs, the physical result is the creation of entries in the prototype actor file similar to the indications shown in Tables 1-3 above. As a further example, if the game developer drags and drops an image file of a space ship into the image page 1702 of the actor editor, such action associates the image with the prototype actor. The physical result is the creation of entries in the prototype actor file that designates the relationship similar to the indications in Table 4 above. Every attribute and conduct (i.e., behaviors and/or actions) created or modified by the project editor 100 has a resulting representing in the PGF game representation.

Runtime Engine

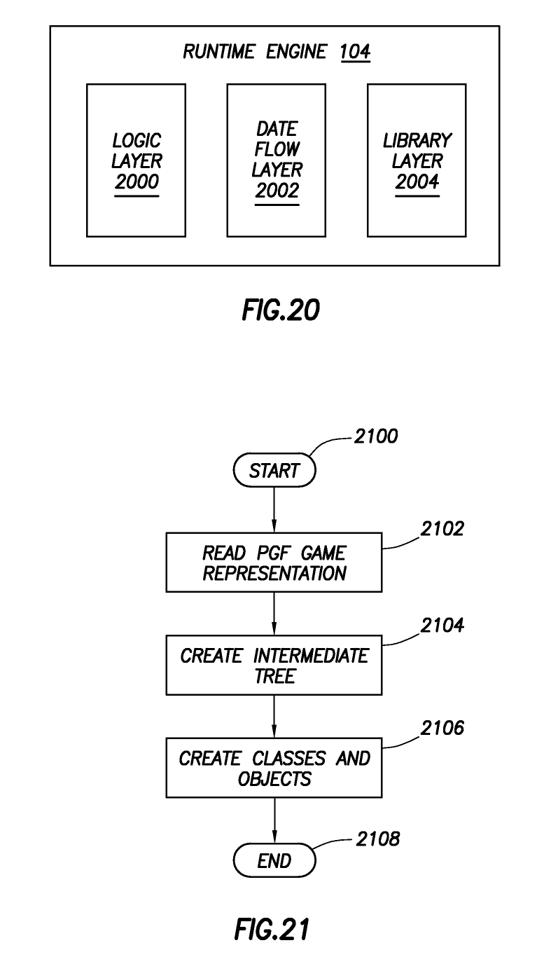

The specification now turns to a more detailed description of the runtime engine. FIG. 20 shows in block diagram form the logical components of the runtime engine 104. While designated with respect to the runtime engine 104, the description is equally applicable to the illustrative runtime engines 200, 202, and 204. In particular, the runtime engine 104 may be considered to have three logical components: logic layer 2000; data flow layer 2002; and library layer 2004. Each of the illustrative layers will be discussed in turn.

The logic layer 2000 is a program or routine that performs initial steps in preparing to execute the game. FIG. 21 shows a method related to the logic layer 2000 in accordance with at least some embodiments. In particular, the method starts (block 2100) and proceeds to reading the PGF game representation (block 2102). In a particular embodiment, reading the PGF game representation involves reading a series of folders and files, where the files are coded in XML. From the PGF game representation, the illustrative method involves creating an intermediate tree (block 2104). The intermediate tree is a logical representation or organization of the game based on the prototype actors, scenes, and actor instances within the scenes. From the intermediate tree, the next step in the illustrative method is the creation of classes and objects (block 2106) of the game, and thereafter the method end (block 2108). In a particular embodiment, the classes and objects are created in the Lua programming or scripting language. Other programming languages may be equivalently used to create the classes and objects of the game, such as the C++ programming language, or Java® brand programming language. Stated otherwise, the PGF game representation is used as the basis to create classes and objects in an object oriented programming language.

The classes and objects that rely on hardware to determine values “register” with an event center object. The event center routine is the “clearinghouse” for routing data from the hardware (e.g., mouse position, accelerometer reading, inclinometer reading). As different values are received from the hardware devices, the data is dispatched to the appropriate classes and objects in the logic layer 2000. Each end device upon which an interactive game is played may have a different native “front end” that acts as the abstraction layer between the hardware and software, and thus each runtime engine is specifically designed to interface with the respective native front end. For example, when a key is pressed, a an event is detected by the native front end, which calls an appropriate application programming interface of the runtime engine. The application programming interface posts the event to the event center, and the event center delivers the event to any rules or behaviors that are registered to receive the data.

Returning to FIG. 20, the data flow layer 2002 is a program or routine that interfaces between the objects created by the logic layer 2000 and library layer 2004. The precise number of executable objects (nodes) in the data flow layer depends directly on the number of objects within a particular scene. However, the data flow layer 2002 can be considered to create executable code portions at runtime responsive to the scene and actors within the scene, and the data flow layer changes executable code with changes of scene, and in some cases with changes within a scene. Nodes may be created responsive to classes and/or objects at the logic layer, and the nodes created may read data from the logic layer and pass data directly to the library layer 2004, or nodes may pass data to other nodes within the data flow layer 2002. Thus, the data flow layer 2002 does not replace or supplant the logic layer 2000; rather, the data flow later 2002 relies upon the logic layer as the repository for data about the game (e.g., an actor's current position or velocity). Moreover, data flow through the data flow layer 2002 not only operates in the “push mode”, where changes at the logic layer are pushed through the data flow layer 2002, but also in a “pull mode”, where the library layer 2004 can trigger the data flow layer to read the latest data from the logic layer 2000.

The next illustrative layer is the library layer 2004. The library layer 2004 can be considered to serve at least two purposes—interface with the hardware upon which the game executes, and implement the physics engine. In particular, the library layer 2004 is or has the executable code or routines that interface with the particular hardware. For example, the library layer 2004 may interface with graphics hardware, such as making application programming interface (API) calls consistent with the Open Graphics Library (OpenGL) standard specification. As another example, the library layer 2004 may interface with sound hardware, such as making API calls consistent with the Open Audio Layer (OpenAL) API. The library layer 2004 may perform other tasks as well, as reading user input (e.g., reading keyboard entries, reading touch screen entries, reading device accelerometer, and reading device inclinometer).

The second illustrative purpose of the library layer 2004 is to implement the underlying physics engine for the game. In some embodiments, game play controlled or constrained under a rigid-body physics engine that approximates real-world physical interactions. Each actor configured to have physical interaction is simulated by the physics systems after the actors' behaviors and actions are evaluated.

Example Computing Environment

The various embodiments discussed to this point operate on computer systems of varying forms. For example, the project editor 100 and runtime engine 104 may execute on a desktop or laptop computer system. The deliverables 206, 208, and 210 may execute on any appropriate hardware, such as a iPhone® or iPad® brand product.

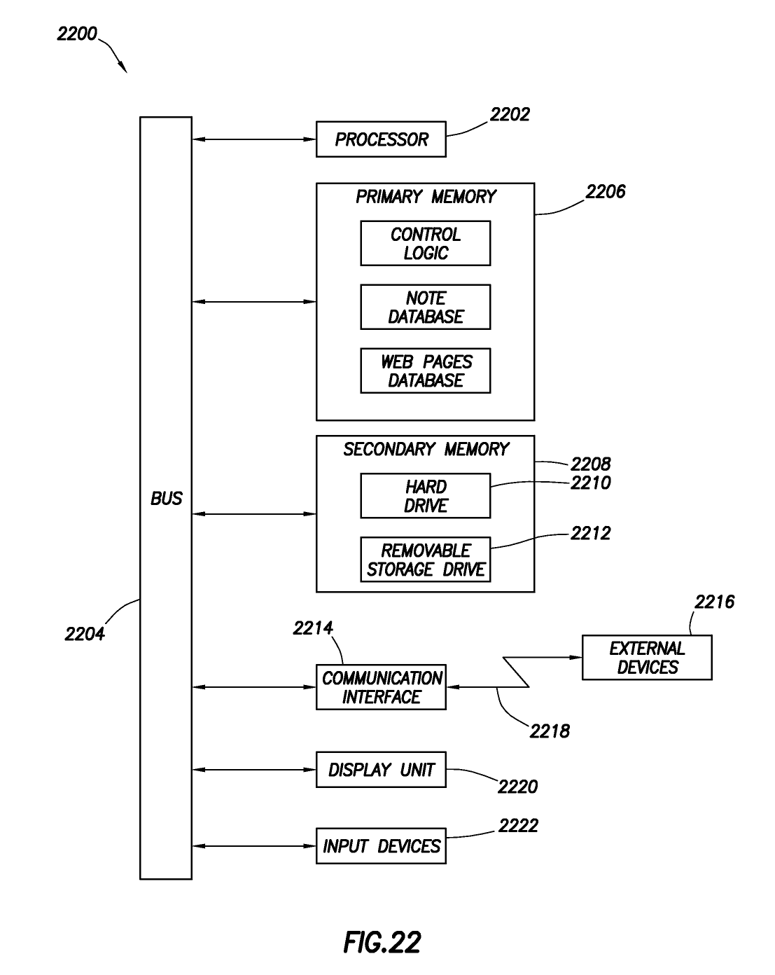

FIG. 22 shows an illustrative computer system 2200 in accordance with at least some embodiments. The illustrative computer system 2200 could be the environment on which the project editor 100 and runtime engine 104 are executed, and the illustrative computer system 2200 could be the computer system on which a specific deliverable 206, 208, and 210 may be executed. The computer system 2200 comprises one or more processors, such as a processor 2202. The processor 2202 is coupled to a communication bus 2204. The computer system 2200 also comprises a main or primary memory 2206. The computer system 2200 may also comprise a secondary memory 2208. The secondary memory 2208 may, for example, a hard disk drive 2210 and/or a removable storage drive 2212. Both the primary memory 2206 and the secondary memory 2208 are examples of computer-readable mediums upon which programs (executable by the processor 2202) may be stored. Moreover, the primary memory 2206 and the secondary memory 2208 are examples of computer readable mediums upon which PGF game representations may be stored.

The illustrative computer system 2200 may also comprise communication interface 2214. The communications interface 2214 enables the computer system 2200 to communicate and interact with locally or remotely located external devices 2216 via a communications medium 2218. In particular, communications interface 2214 enables the computer system 2200 to send and receive software and data to/from the external devices 2216. Examples of the communications interface 2214 comprise a modem, a network interface (such as a wired or wireless Ethernet card or a cellular card), a communications port, etc. The illustrative computer system 2200 may also comprise a display unit 2220, such as a computer monitor, and one or more input devices 2222, such as a keyboard and a pointing device (such as a mouse, trackball, etc.). One skilled in the art will readily recognized that the components described herein are employed in numerous computing devices, including, without limitation, personal computers, cell phones, portable music players that incorporate display, and tablet computers.

Behaviors and Actions

The following is a list of illustrative behaviors that may be associated with actors in the various embodiments.

Accelerate behavior—The Accelerate behavior specifies the acceleration and direction (angle) of an actor. The Accelerate behavior can be used in conjunction with a rule or trigger that is specifiable by the user (e.g., a keyboard event). When activated, the Accelerate behavior accelerates the actor until the maximum define speed is achieved. It is noted that since the Accelerate behavior is directional, and thus an acceleration in an opposite direction to a current motion may result initial in deceleration, followed by acceleration.

Accelerate Toward behavior—The Accelerate Toward behavior specifies the acceleration and location (e.g., X,Y location) toward which an actor accelerates. The Accelerate Toward behavior can be used in conjunction with a rule or trigger that is specifiable by the user (e.g., a keyboard event). When activated, the Accelerate Toward behavior accelerates the actor until the maximum define speed is achieved.

Animate behavior—The Animate behavior enables animating a series of images (at a particular frame rate). The animation of the series of images may be set to loop (play on a continuous loop), stop at the last frame, or return to the last image before the Animate behavior is triggered.

Call External Function action—The Call External Function action enables interactive applications to call functions executable functions (i.e., third party libraries).

Change Attribute action—The Change Attribute action enables the setting, change or incrementing of an attribute associated with an actor. For example, Change Attribute may be used to change an actor's color, increment/decrement a value associated with the actor (e.g., actor created to keep score, or an actor created to track remaining lives).

Change Image action—The Change Image action enables changing the image associated with the actor, the change based on the occurrence of an event (e.g., collision of two actors, winning the game).

Change Scene action—The Change Scene action enables the game to change to a different scene based on the occurrence of an event.

Change Size action—The Change Size action enables changing the physical size of the actor as rendered on the screen in response to the scale factor. The Change Size action includes growth in size of an actor (e.g., by a positive scale factor) and shrinking size of an actor (e.g., by a negative scale factor).

Change Velocity action—The Change Velocity action enables movement of an actor at a particular velocity, the movement relative to the actor or to the scene.

Collide behavior—The Collide behavior enables actors or group of actors to collide with one another in elastic-style collisions.

Constrain Attribute behavior—The Constrain Attribute behavior enables constraint of an attribute of an actor to a particular value (continuously updates the attribute). May be used, for example, to constrain an actor's X,Y position that that of input device, such as a position indicated by a pointing device or touch screen.

Camera Control behavior—The Control Camera behavior controls the location of the “camera” (i.e., the point of view from which the scene is rendered on a display device) relative to an actor to keep the actor in view.

Destroy action—The Destroy action removes an actor from a scene based on a occurrence of event.

Display Text behavior—The Display Text behavior enables, by way of an actor, for the rendering of text on the display device within a scene. The text rendered may be based on expressions that take input data from other actors in the scene.

End Game action—The End Game action causes, upon the occurrence of an event, the game to end.

Group behavior—The Group behavior creates a logical grouping of behaviors and actions. Behaviors and actions within the group still operate based on their respective triggers.

Interpolate behavior—The Interpolate behavior interpolates an attribute of an actor from one value to another.

Load Attribute action—The Load Attribute action enables reading a value from a persistent storage device, and loading the value into an attribute of an actor.

Move behavior—The Move behavior enables the movement of an actor at a particular angle relative to the actor or to the scene.

Move To behavior—The Move To behavior enables movement of an actor toward a specific X,Y coordinate relative to the actor or the scene. The Move To behavior can be configured to run to completion, or can be controlled based on a parameter such that the movement toward the final location starts and stops as a function of other conditions.

Note behavior—the Note behavior does not result in any action of an action; rather, the note behavior is a mechanism by which the game developer makes notes about another behavior, rule, or group, where such note will be visible during periods of time when the behaviors and/or actions are being edited.

Open URL action—The Open URL action enables opening of web pages in the default web browser.

Particles behavior—The Particles behavior creates, relative to an actor, a radial explosion or fountain of particles. The Particles behavior also enables setting or changing the image of an actor, color of the particles, and length of time the explosion or fountain of particles occurs.

Pause Game action—The Pause Game action pauses the game based on the occurrence of an event, including displaying a selectable pause screen, and rendering text over the screen indicating the game is paused.

Pause Music action—The Pause Music action pauses the currently playing music based on the occurrence of an event.

Play Music action—The Play Music action triggers a music file to play. The music file may be set to play once, or to loop repeatedly.

Play Sound action—The Play Sound action triggers a sound file to play. The sound file may be set to play once, or to loop repeatedly.

Replicate behavior—The Replicate behavior enables replication of an actor within a scene based on the occurrence of an event. The number of copies created in the replication is settable directly or through an expression.

Reset Game action—The Reset Game action resets the game and all scenes within the game, with the reset based on a selectable triggering event.

Reset Scene action—The Reset Scene action resets the current scenes, with the reset based on a selectable triggering event.

Rotate behavior—The Rotate behavior creates a constant clockwise or counter-clockwise rotation of an actor. The Rotate behavior can be triggered by a selectable triggering event, such as when a keyboard key is pressed.

Rotate To Angle behavior—The Rotate To Angle behavior rotates an actor to a specified angle relative to the actor or the scene. The Rotate to Angle behavior can be triggered by a selectable triggering event, such as when a keyboard key is pressed. Moreover, the specified angle may be a constant, or may determined by an expression based on other game play variables.

Rotate To Position behavior—The Rotate To Position behavior rotates an actor to a specified X,Y coordinate on the screen or relative to the actor. The Rotate to Position behavior can be triggered by a selectable triggering event, such as when a keyboard key is pressed. Moreover, the specified X,Y may be a constant, or may determined by an expression based on other game play variables.

Rule behavior—The Rule behavior creates condition or set of conditions to check for user input or attribute changes of an actor. The Rule behavior can be the triggering event for other behaviors and actions, or can define input information for operation of other behaviors, such as a Move To location. Stated otherwise, the Rule behavior activates or deactivates other behaviors and actions.

Save Attribute action—The Save Attribute action enables the saving of an attribute, under a custom key name, to a persistent memory. The Save Attribute action may be used in conjunction with the Load Attribute action.

Show iAd action—The Show iAd action enables the display of banner advertisements over an interactive game.

Spawn Actor action—The Spawn Actor action creates a new actor instance within the scene, and enables specifying attributes of the new actor instance, such as direction of movement, angular position relative to the scene or spawning actor.

Stop Music action—The Stop Music action stops any current music that is playing.

Timer behavior—The Timer behavior enables performance of other behaviors (such as Rules) at specified intervals. The specified intervals include: after a predefined or selectable number of seconds; every predefined or selectable number of seconds; and for a predefined or selected number of seconds.

Unpause Game action—The Unpause Game action removes the pause screen, restores the game to the previous scene, and resumes the game.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments, and/or to create a non-transitory computer-readable storage medium (i.e., other than an signal traveling along a conductor or carrier wave) for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. For example, while the various software components have been described in terms of game creation, the development context shall not be read as a limitation as to the scope of the one or more inventions described—the same techniques may be equivalently used for non-game programming. That is, the programming interfaces, portable format, and execution engine operation are equally applicable to any interactive multimedia application development, such as interactive books, interactive novels, educational tools, and animation. It is intended that the following claims be interpreted to embrace all such variations and modifications.

What is claimed is:

1. A method comprising:
accepting an indication of flow of an interactive application, the accepting by way of a graphical user interface (GUI) of an interface program executed on a computer system, and the indication of flow at least partially in a declarative format;
creating a representation of the flow of the interactive application, the representation of the flow within a file accessible by the computer system, the representation of the game play at least partially in a declarative format, and the creating by the interface program; and
executing the interactive application by a first runtime engine, the first runtime engine becomes executable code to implement the interactive application based on reading the representation of the flow of the interactive application.

2. The method of claim 1 wherein creating the representation further comprises:
creating a representation of a prototype actor in an actor file;
creating a representation of a scene in a scene file, wherein the scene file has an indication of an actor instance related to the prototype actor.

3. The method of claim 2 wherein creating the representation of the scene file further comprises placing the indication of the actor instance in the scene file where the indication of the actor instance couples a first attribute to a corresponding first attribute of the prototype actor, and the indication of the actor instance de-couples a second attribute from a corresponding second attribute of the prototype actor.

4. The method of claim 2 wherein creating the representation of the scene file further comprises placing the indication of the actor instance in the scene file where the indication of the actor instance couples a first behavior to a corresponding first behavior of the prototype actor, and the indication of the actor instance de-couples a second behavior from a corresponding second behavior of the prototype actor.

5. The method of claim 1 further comprising combining the representation of flow of the interactive application with a second runtime engine to create a first executable deliverable of the interactive application, and the representation of flow is distinct from the second runtime engine within the first executable deliverable.

6. The method of claim 5 further comprising combining the representation of flow of the interactive application with a third runtime engine to create a second executable deliverable, the third runtime engine distinct from the second runtime engine, and the representation of flow distinct from the third runtime engine within the second executable deliverable.

7. The method of claim 1 wherein creating the representation further comprises:
creating a representation of a prototype actor in an actor file, wherein the representation of the prototype actor defines a first behavior and a second behavior distinct from the first behavior, and where the second behavior is dependent upon the first behavior;
creating a representation of a scene in a scene file, wherein the scene file has an indication of an actor instance related to the prototype actor.

8. The method of claim 7 wherein creating the representation of the scene in the scene file further comprises creating an indication that the actor instance has a third behavior, distinct from both the first and second behaviors.

9. A method comprising:
executing an interactive application on a computer system comprising:
receiving an indication of design of the interactive application, the indication of design not directly executable by the computer system, and the indication of game play not depicted in a programming language; and then
creating an indication of objects of the interactive application in an object oriented programming language, the creating based on the indication of design;
executing node routines, each node routine instantiated based on one or more of the objects; and
directing, by at least some of the node routines, the rendering of images on a display device that depicts design of the interactive application.

10. The method of claim 9 wherein, prior to creating the indication of objects in the object oriented programming language, the method further comprises:
creating an intermediate tree that represents the interactive application; and
wherein creating the indication of objects further comprises creating the indication of objects based on the intermediate tree.

11. The method of claim 9 wherein receiving an indication of design of the interactive application further comprises receiving the indication coded in extensible markup language (XML).

12. The method of claim 9 wherein receiving an indication of design of the interactive application further comprises receiving the indication coded in Java Script Object Notation (JSON).

13. A non-transitory computer-readable medium storing a program that, when executed by a processor, causes the processor to:
read a representation of an interactive application from the computer-readable medium, the representation not directly executable by the processor, and the representation the interactive application not depicted in a programming language; and then
configure the processor to execute consistent with the representation the interactive application, and when the processor executes consistent with the representation of the interactive application, the program causes the processor to:
create an indication of objects of the interactive application in an object oriented programming language;
execute node routines, each node routine instantiated based on one or more of the objects; and
direct, by at least some of the node routines, the rendering of images on a display device that depict design of the interactive application.

14. The non-transitory computer-readable medium of claim 13 wherein, prior to when the processor creates the indication of objects in the object oriented programming language, the program further causes the processor to:
create an intermediate tree that represents the interactive application; and
wherein when the processor creates the indication of objects, the program further causes the processor to create the indication of objects based on the intermediate tree.

15. The non-transitory computer-readable medium of claim 13 wherein when the processor reads the representation of the interactive application, the program further causes the processor to read the representation of the interactive application coded in extensible markup language (XML).

16. The non-transitory computer-readable medium of claim 13 wherein when the processor reads the representation of the interactive game, the program further causes the processor to read the representation of the interactive application coded in Java Script Object Notation (JSON).

17. A non-transitory computer-readable medium storing a program that, when executed by a processor, causes the processor to:
create executable deliverables of an interactive application, and when the processor creates the executable deliverables the program causes the processor to:
read representation of the interactive application, the representation not directly executable by the processor, and the representation the interactive game not depicted in a programming language;
package the representation of the interactive application with a first runtime engine to create a first executable deliverable, the representation of the interactive application distinct from the first runtime engine within the first executable deliverable.

18. The non-transitory computer-readable medium of claim 17 wherein the program further causes the processor to package the representation of the interactive application with a second runtime engine to create a second executable deliverable, the second runtime engine distinct from the first runtime engine, and the representation of the interactive application distinct from the second runtime engine within the second executable deliverable.

19. The non-transitory computer-readable medium of claim 18 further comprising:
wherein when the processor packages the representation of the interactive application with the first runtime engine, the program causes the processor to package with the first runtime engine configured for operation with a processor implementing a first instruction set; and
wherein when the processor packages the representation of the interactive application with the second runtime engine, the program causes the processor to package with the second runtime engine configured for operation with a processor implementing a second instruction set, different than the first instruction set.

20. A computer system comprising:
a processor;
a memory coupled to the processor;
wherein the memory stores a program that, when executed by the processor, causes the processor to:
accept an indication of design of an interactive application, the accepting by way of a graphical user interface (GUI), and the indication of game play at least partially in a declarative format;
create a representation of the design of the interactive application, the representation of the design within a file accessible by the computer system, the representation of the design at least partially in a declarative format; and
executing the interactive application, the program becomes executable code to implement the interactive game based on the representation of the game play.

21. The computer system of claim 20 wherein when the processor creates the representation, the program further causes the processor to:
create a representation of a prototype actor in an actor file;
create a representation of a scene in a scene file, wherein the scene file has an indication of an actor instance related to the prototype actor.

22. The computer system of claim 21 wherein when the processor creates the representation of the scene file the program further causes the processor to place the indication of the actor instance in the scene file where the indication of the actor instance couples a first attribute to a corresponding first attribute of the prototype actor, and the indication of the actor instance de-couples a second attribute from a corresponding second attribute of the prototype actor.

23. The computer system of claim 21 wherein when the processor creates the representation of the scene file, the program further causes the processor to place the indication of the actor instance in the scene file where the indication of the actor instance couples a first behavior to a corresponding first behavior of the prototype actor, and the indication of the actor instance de-couples a second behavior from a corresponding second behavior of the prototype actor.

24. The computer system of claim 20 wherein when the processor creates the representation, the program further causes the processor to:
create a representation of a prototype actor in an actor file, wherein the representation of the prototype actor defines a first behavior and a second behavior distinct from the first behavior, and where the second behavior is dependent upon the first behavior; and
create a representation of a scene in a scene file, wherein the scene file has an indication of an actor instance related to the prototype actor.

25. The computer system of claim 24 wherein when the processor creates the representation of the scene in the scene, the program further causes the processor to create an indication that the actor instance has a third behavior, distinct from both the first and second behaviors.
